(19) United States
(12) Patent Application Publication
(10) Pub. No.: US 2024/0118295 A1
(43) Pub. Date: Apr. 11, 2024

(54) APPARATUS AND METHODS FOR TRANSFERRING A TISSUE SECTION

(71) Applicant: Agilent Technologies, Inc., Santa Clara, CA (US)

(72) Inventors: Kyle SCHLEIFER, Somerville, MA (US); Victor LIM, Pacifica, CA (US); Richard K. WORKMAN, Sunnyvale, CA (US)

(21) Appl. No.: 18/264,690

(22) PCT Filed: Jan. 31, 2022
(86) PCT No.: PCT/US2022/014582

§ 371 Date: Aug. 8, 2023

Related U.S. Application Data
(60) Provisional application No. 63/147,392, filed on Feb. 9, 2021.

(51) Int. Cl. G01N 35/00; G01N 1/28

(52) U.S. Cl. CPC G01N 35/00029; G01N 1/2813; G01N 2001/2833; G01N 2035/00138

(57) ABSTRACT

The invention relates to apparatus and methods for automated tissue sectioning, including slicing and transferring a tissue section to a slide. The invention also relates to automated systems and methods for transferring a tissue section onto a slide using an adhesive strip.

### CROSS-REFERENCE TO RELATED APPLICATIONS

This application is a US national stage entry of PCT/US2022/014582, filed Jan. 31, 2022, which claims priority to and benefit of U.S. Patent Application No. 63/147,392, filed on Feb. 9, 2021, the contents of which are incorporated herein by reference in its entirety.

### FIELD OF THE INVENTION

The invention relates to apparatus and methods for transferring a tissue section from a microtome to a slide, including automated systems and methods.

### BACKGROUND OF THE INVENTION

Microtomes are used to cut extremely thin slices of tissue, known as tissue sections, for microscopic observation under transmitted light or electron radiation. Microtomes use extremely sharp knives to slice thin tissue sections of a desired thickness from a sample. The knife is held by a knife holder which can be adjusted to cut at a selected thickness. The tissue sections can then be retrieved from the microtome, usually by manual retrieval, such as by an operator using a grasping tool, transferred to a slide, and examined with an optical or an electron microscope or by other techniques. Because the tissue sections are extremely thin, with some having sub-micron thickness, they may be difficult to collect and transfer without damage or contamination.

A rotary microtome such as the Leica RM2125 RTS comprises a handwheel that moves a sample holder downward, so that the held sample is sliced by the knife. The rotary microtome has a housing on which a knife holder, the sample holder, the handwheel and other elements are all assembled, with various clamps for holding the moving pieces in position. The knife holder typically includes a front plate, and the sliced tissue section may lie on the front plate after slicing. The slicing is a manual operation, with each section being sliced via rotation of the handwheel.

US Patent Application Publication No. 20040261597 to Thiem et al. discloses a rotary microtome having a base part on which a microtome housing and a knife holder are arranged. A collection element surrounds the knife holder on three sides and has a U-shaped base outline. Several clamping levers are associated with the knife and knife holder, the clamping lever to the knife holder is on the outside of the collection element, reducing the number of levers on the knife holder and simplifying cleaning. The collection element is configured so that tissue sections may be easily cleaned out of it and so that the user does not get caught on it or the microtome housing.

US Patent Application Publication No. 20100216221 to Walter et al. discloses a device for applying a histological section to a slide. The histological section is generated by a cutting action performed by a blade of a microtome. The device comprises a positioning device having a component that is rotatably mounted to a bearing and has a receptacle for receiving and holding the slide, wherein the positioning device is designed such that the slide received in the receptacle can be rotated about an axis of rotation of the rotatably mounted component.

US Patent Application Publication No. 20090181457 to Schmitt discloses an apparatus and a method for isolating histological sections produced with a microtome. A previously and currently produced histological section are connected to form a section strip. In order to simplify isolating the previously and currently produced histological sections from each other, a nozzle device is provided by means of which the histological sections when positioned on a blade holder are subjected to an air stream of adjusted direction and intensity so that the previously produced histological section of the section strip is separated from the currently produced histological section that is positioned on the blade holder and is removed from the blade holder.

US Patent Application Publication No. 20150168277 to Magavi et al. discloses apparatuses and methods for handling a portion of a tissue sample when sectioned by a microtome. The apparatuses include a container, a tissue sample holder in the container, and one or more outlets configured to allow flow of a fluid from the container. The flow through the outlet causes a portion of the tissue sample sectioned by a microtome to move into the outlet. The methods include sectioning one or more portions of a tissue sample, and flowing a fluid past the tissue sample to cause the one or more portions of the tissue sample to move away from the tissue sample and toward at least one fluid outlet.

US Patent Application Publication No. 20150198509 to Williamson et al. discloses an automated machine for handling and embedding tissue samples contained on microtome sectionable supports. The machine includes an input member configured to hold a plurality of the microtome sectionable supports prior to a tissue embedding operation. An output member is configured to hold a plurality of the microtome sectionable supports after the tissue embedding operation. A cooling unit is configured to hold at least one of the microtome sectionable supports during the tissue embedding operation. A motorized carrier assembly is mounted for movement and configured to hold at least one of the microtome sectionable supports. The carrier assembly moves the support from the input member to the cooling unit and, finally, to the output member. A dispensing device dispenses an embedding material onto the microtome sectionable support and at least one tissue sample carried by the microtome sectionable support during the embedding operation.

A traditional approach for slicing tissue sections using a microtome involves creating a strip or ribbon of tissue sections from a tissue sample (such as a tissue embedded in paraffin). After a tissue section is created, the trailing edge of the section adheres to the knife, which allows an attachment site between the sliced tissue section and a subsequently sliced section, and so on, thereby creating a ribbon of tissue sections. Often only one or two sections from the ribbon are actually used and mounted onto a slide, since the first section sliced by the microtome is hard to manipulate without damage. This causes the first section to be a sacrificial section and waste of the sample. Often the first section of the ribbon will curl or collide with the knife holder, requiring the user of the microtome to intervene so as to remove the tissue section. If the first section sliced from the sample block could be obtained without this user intervention, the first section could be used directly and it would remove the need to create a ribbon.

US Patent Application Publication No. 20140345433 to Studer discusses a device for transferring a section ribbon to a specimen holder for use in transmission electron microscopy (TEM), the section ribbon being transferred to the specimen holder by way of an ionization device in a microtome apparatus.

US Patent Application Publication No. 20150168275 to Orfield et al. discusses the need for an improved system for mounting a tissue section on a slide: It is commonly desirable in biological laboratories to mount tissue sections to slides for purposes of examining the tissue sections using a microscope, treating the tissue sections with a stain or dye, and for other purposes. Conventional systems and methods for mounting specimens onto slides comprise placing tissue sections in a sufficiently deep water bath, with the specimens floating on the surface of the water. The narrow side of a slide is then rested on the rim of the water bath and the slide is angled down into the water back such that the slide is partially submersed in the water. Subsequently, a small brush or glass capillary tube is used to manipulate a tissue section onto the slide. Typically, the slide is gradually drawn out of the water as additional tissue sections are arranged on the slide. In another variation of a conventional method, tissue is embedded in paraffin wax, sliced with a microtome, and then selected sections of the embedded tissue are transferred to a heated water bath. The hot water bath partially melts the paraffin about the specimens, and a glass slide treated with adherents is then used to scoop the tissue sections out of the hot water bath. Conventional methods of mounting specimens on slides are thus difficult, time-consuming, and labor-intensive.

Orfield also discusses a system and method for mounting a section onto a substrate. The system comprises a fluid channel including: a fluid channel inlet that receives the section, processed from a bulk embedded sample by a sample sectioning module positioned proximal the fluid channel inlet, a section-mounting region downstream of the fluid channel inlet, and a fluid channel outlet downstream of the section-mounting region; a reservoir in fluid communication with the fluid channel outlet; and a manifold, fluidly coupled to the reservoir, that delivers fluid from the reservoir to the fluid channel inlet, thereby transmitting fluid flow that drives delivery of the section from the fluid channel inlet toward the section-mounting region.

US Patent App. Pub. 20140287456 to Angros discusses a method of removing a floatation liquid from between a microscope slide and a paraffin embedded biological specimen. The microscope slide with the paraffin embedded biological specimen floated thereon is positioned onto a slide support element. The slide support element is rotated to cause the microscope slide and the paraffin embedded biological specimen to move in a way that causes the floatation liquid disposed between the microscope slide and the paraffin embedded biological specimen to be removed from between the microscope slide and the paraffin embedded biological specimen.

US Patent App. Pub. 20170284904 to Lim et al. discusses apparatus and methods for automated tissue sectioning, including slicing and transferring a tissue section from a microtome. The publication also discusses automated systems and methods for slicing and transferring a tissue section onto a slide

US Patent App. Pub. 20180246017 to Lim discusses methods and apparatus for transfer of a tissue section from a first location to a second location. Thermoplastic material is applied to at least one pin of a tissue section transferring apparatus. The thermoplastic material contacts a tissue section while at least partially melted, and when it cools, substantially solid thermoplastic material holds the tissue section to the at least one pin. A tissue section transferring apparatus comprises a heater block, a heat source, and at least one pin attached to and extending from the heater block.

U.S. Pat. No. 4,545,831 to Ornstein discusses a method for transferring a thin tissue section affixed to a substrate by a first pressure-sensitive adhesive layer to a microscope slide which supports a second pressure-sensitive adhesive layer of polymerizable material. The tissue section is contacted to the second adhesive layer to form a laminate. Following polymerization of the second layer to form a positive bond between the tissue section and microscope slide, the substrate and first adhesive layer are completely removed to expose the tissue section, now affixed to the microscope slide by the polymerized second adhesive layer, for subsequent processing.

Apparatus and methods for automated collection and transfer of a tissue section from a microtome to a slide are desired, especially those with greater speed and efficiency and while maintaining high quality of tissue sections.

### SUMMARY OF THE INVENTION

As one aspect of the present invention, a method is provided for transferring a tissue section onto a slide. The method comprises collecting a tissue section with a tissue collector and/or an adhesive strip. The method also comprises moving the tissue collector and/or the adhesive strip to bring at least a portion of the tissue section in contact with a slide, applying physical force, heat or both to the tissue section at a contact site of the tissue section with the slide. Using the present methods, the tissue section can be easily and reliable transferred to the slide without manual contact with the tissue section.

The present method can comprise positioning an adhesive strip on a collecting end of the tissue collector, and the tissue section may be collected by adhering it to the adhesive strip. In some embodiments, an adhesive strip is provided or wound on a first reel, and the adhesive strip extends or unwinds from the first reel across the collecting end to a second reel. The adhesive strip can be advanced across the collecting end (such as by unwinding a portion from the first reel and winding a portion on the second reel) after a first section of the adhesive strip is used to transfer a tissue section to a slide. In this manner, a second, unused section of the adhesive strip can be positioned on the collecting end.

As another aspect, an apparatus is provided for transferring a tissue section to a slide. The apparatus comprises a tissue collector adapted for collecting the tissue section, a slide holder adapted for holding a slide, and a heating element. The tissue collector and/or the slide holder is configured for movement such that a tissue section collected by the tissue collector and a slide held by the slide holder contact at a contact site. The heating element is positioned at, or configured for movement to, the contact site. A tissue collector and/or the slide holder can be configured for rotational motion, linear motion, or both. In some embodiments, a tissue collector and/or the slide holder are configured for automated movement.

In some embodiments, the heating element is contained within the tissue collector or the slide holder. Additionally or alternatively, a heating element is outside the tissue section and the slide holder, and a heating element is positioned, or capable of movement to a position, on a first side of a slide held by the slide holder, wherein the contact site is a second, opposite side of the slide. The heating element can be configured and positioned to provide heat to a top portion of a tissue section. In some embodiments, the apparatus further comprises a dispenser for an adhesive material.

As yet another aspect, an apparatus is provided for transferring a tissue section to a slide, comprising a tissue collector adapted for collecting the tissue section; a slide holder adapted for holding a slide, and an adhesive strip dispenser capable of dispensing an adhesive strip at the collecting end of the tissue collector. The tissue collector and/or the slide holder can be configured for movement such that a tissue section collected by the tissue collector and a slide held by the slide holder contact at a contact site. In some embodiments, the adhesive strip dispenser comprises at least two reels on opposite sides of the collecting end, and an adhesive strip extends from a first reel across the collecting end to a second reel. The first reel is capable of unwinding fresh adhesive strip, and the second reel is capable of winding used adhesive strip. It is advantageous that the collecting end of the tissue collector is extendible to facilitate collection of a tissue section, so the adhesive strip dispenser should be configured so that it does not interfere or prevent extension of the collection end. In some embodiments, the tissue collector is configured to transfer the tissue section by application of physical force and/or heat at or near the slide holder. In some embodiments, the tissue collector or the slide holder comprises a heating element.

The foregoing apparatus can further comprise a microtome comprising a sample holder, a knife holder and a knife held by the knife holder opposite the sample holder, such that when the sample holder is moved linearly, a sample held by the sample holder is sliced by the knife to form a tissue section. The foregoing apparatus can also comprise a slide bath, and the slide holder can be configured to submerge a slide in the slide bath.

The present methods can further comprise slicing a tissue section from a tissue sample with a microtome; extending the tissue collector so as to collect the tissue section from the microtome; and/or adhering the sliced tissue section to the tissue collector using an adhesive, reduced pressure, friction, or other force. The present methods and apparatus can further comprise moving the slide holder and the adhered tissue section to a slide bath containing a liquid; and/or submerging the slide and the adhered tissue section in a liquid.

The foregoing apparatus and methods can also comprise a control system configured to automate heating of the tissue section by the heater. The foregoing apparatus and methods can also comprise a user interface in communication with the controller, wherein the user interface is adapted to display or report on availability of the adhesive material.

### BRIEF DESCRIPTION OF THE DRAWINGS

FIG. 1 illustrates an exemplary embodiment of a tissue collector comprising a heating element.

FIG. 2 illustrates an exemplary embodiment of a slide holder comprising a heating element.

FIG. 3 is a perspective view of an exemplary embodiment of an apparatus for slicing a tissue section and transferring the tissue section to a slide in an automated manner.

FIG. 4 is a diagram of an exemplary embodiment of a tissue collector for holding a tissue section, comprising an adhesive strip dispenser.

### DETAILED DESCRIPTION OF THE INVENTION

Some embodiments of the present invention are based, at least in part, on reducing or eliminating manual steps in collecting and transferring tissue sections from a microtome to a slide. Some embodiments of the present invention are also based on an improved way of attaching a tissue section to a slide. A tissue section is an extremely thin slice of a tissue which may be suitable for microscopic examination, for example, slices having a thickness from about 1 to about 100 microns, alternatively from about 1 to about 30 microns, alternatively from about 3 to about 10 microns. Caution and expertise are required for manual transfer of a tissue section to a slide.

In some embodiments of the present methods and apparatus, a tissue section is attached to a slide by applying heat, physical force, or both at a contact site between the tissue section and the slide. The heat, physical force, or both can be applied by a tissue collector and/or a slide holder. The tissue collector collects a tissue section from a microtome that was used to slice the tissue section from a tissue sample. A tissue collector may collect a tissue section from other devices or locations rather than a microtome, such as from a storage location. The tissue collector can be configured to apply heat, physical force or both to the tissue section after moving the tissue section into contact with a slide. The slide may be held by a slide holder; and in some embodiments, a heating element disposed on or within the slide holder can apply heat to the tissue section. The tissue collector and the slide holder can be parts of a larger apparatus which provides automation of the tissue collector and/or the slide holder.

In some embodiments, the tissue section is heated at the contact site to any temperature between about 40° C. and about 90° C., or a temperature sufficient to at least partially melt the embedding medium. Alternatively or additionally, a physical force is applied to a tissue section, such as by applying any physical force of about 275 kPA or less to the tissue section at the contact site, for example, in some embodiments, about 200 kPA or less, or about 125 kPA or less. In some embodiments, the physical force is at least 5 kPA, or at least 25 kPA. In some embodiments, no physical force is applied to the tissue section at the contact site. When the tissue section comprises an embedding medium such as paraffin, it may be desirable that the heat is sufficient to at least partially melt the embedding medium, and/or that the physical force is sufficient to deform or compress the embedding medium. In some embodiments, the embedding medium is at least partially melted and solidified at the contact site, and/or is at least partially compressed and released at the contact site.

The contact site can be an area of any size, shape, or other arrangement. For instance, a contact site can be a thin linear portion of the tissue section at or near a top end, and can extend from one side of the tissue section to an opposite side, or across the width of the tissue section. In some embodiments, the tissue section can be considered to have a top, a bottom, and sides extending between the top and bottom; it can be particularly helpful to consider the tissue section in this way when it is held at its top and the remainder extends downward due to gravity. In some embodiments, the tissue section or a portion thereof is attached to the slide at the contact site, such as by melting embedding medium on the slide. In this context, the tissue section is attached if it remains on the slide as they are moved to a tissue bath. The attachment need not be permanent nor especially strong; it is generally sufficient if it overcomes the force of gravity if the slide is vertical or in a position where gravity would separate it from the slide.

In some embodiments, the contact site and/or the attached portion is at or near a top of the tissue section. It is at the top if it includes the end or edge of the tissue section, and it is near if an end or edge is outside the contact site; for instance, a linear contact site is near the top when it is 1 mm or 2 mm below a top edge. The contact site can be selected or predetermined so that it is less that the entire area of the tissue section, or that it only comprises embedding medium and does not include any of the tissue. In some embodiments, no physical force or heat is applied to the tissue section outside of the contact site. In some embodiments, the contact site and/or the attached portion comprises 50% or less of the area of the tissue section, or 40% or less, or 25% or less, or 20% or less, or 15% or less, or 10% or less, or 7.5% or less, or 5% or less, or 2.5% or less, or 1% or less.

In some embodiments, the present methods can further comprise slicing a tissue section from a tissue sample with a microtome; extending the tissue collector so as to collect the tissue section from the microtome; and/or adhering the sliced tissue section to the tissue collector using an adhesive, reduced pressure, friction, or other force. In some embodiments, the present methods can further comprise moving the slide and the adhered tissue section to a slide bath containing a liquid; and/or submerging the slide and the adhered tissue section in a liquid. Other steps and uses will be apparent from the following description of the present methods and apparatus.

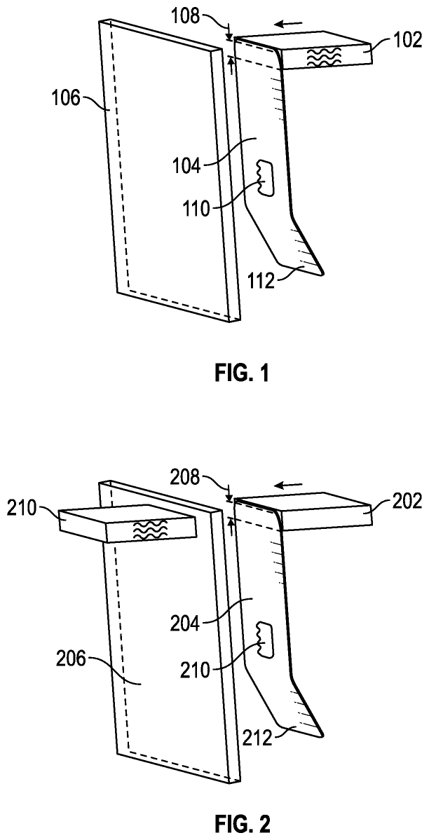

FIG. 1 illustrates an exemplary embodiment in which a tissue collector 102 holds a tissue section 104 at a top end. The tissue section 104 is in a substantially vertical orientation, and it is mostly free or unconstrained and it hangs loosely from the top portion 108 held by the tissue collector 102. Tissue section 104 comprises tissue 110 in an embedding medium 112 such as paraffin. The tissue collector 102 is capable of motion, and in the arrangement or orientation shown in FIG. 1, it extends in a substantially horizontal motion toward slide 106. In some embodiments, the tissue collector 102 applies a physical force to tissue section 104 in contacting slide 106, causing it to attach to slide 106. For instance, a physical force of about 275 kPA or less can be applied, or any amount of physical force sufficient to cause attachment without damaging the slide. The tissue section 104 may be attached to slide 106 as a result of deformation, compression, or other mechanism. As an alternative or in addition to applying a physical force, tissue collector 102 can apply heat to tissue section 104, causing it to attach to slide 106. Preferably, the heat is localized or most confined to the top portion 108. For instance, heat sufficient to cause attachment is supplied, such as, in some embodiments, by heating top portion 108 to a temperature between about 40° C. and about 60° C. In some embodiments, a heat sink can be placed in contact with a top portion of the slide in order to localize the applied heat to the top portion. In some embodiments, the present method prevents applied heat from diffusing down the slide and cause more of the tissue section to adhere to the slide prior to smoothing.

FIG. 2 illustrates another exemplary embodiment of the present methods and apparatus which is similar to the embodiment of FIG. 1, but a heating element 210 is located on an opposite side of slide 206 than tissue section 204. Tissue section 204 comprises tissue 210 in an embedding medium 212 such as paraffin. Tissue collector 202 does not include a heating element, though it is contemplated that an apparatus can have a heater/heating element on both sides of a slide, in a tissue collector 202 and a heating element 210. In FIG. 2, tissue collector 202 holds tissue section 204, transports it from a microtome, extends it toward a slide 206 until tissue section 204 and slide 206 are in physical contact. Heating element 210 applies heat to slide 206 which passes to tissue section 204. As described for FIG. 1, heat should be sufficient to cause attachment, by itself or in combination with physical force applied by tissue collector 202, without damage to the slides.

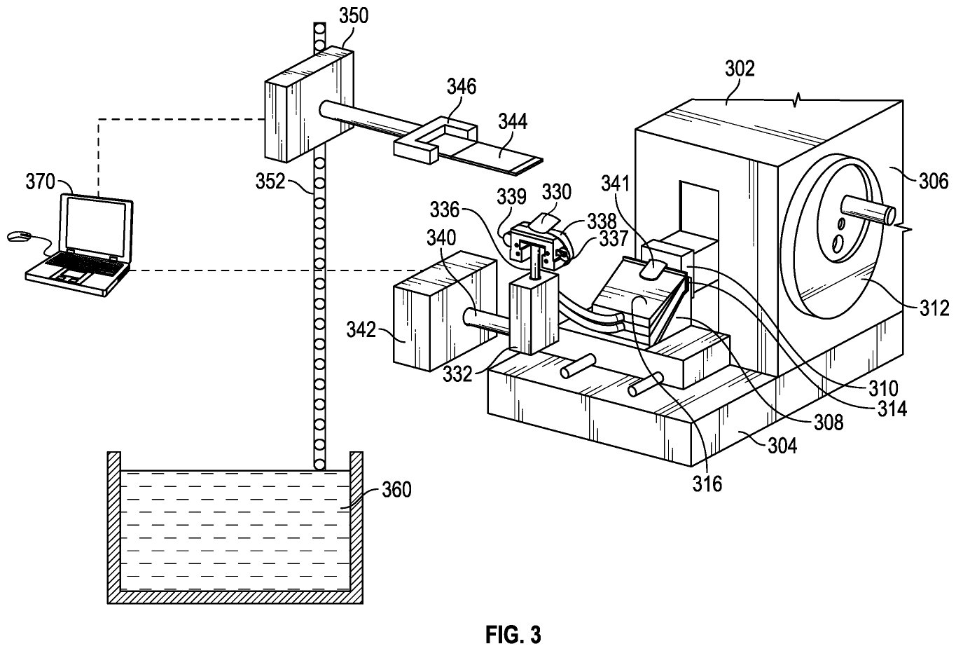

FIG. 3 is a perspective view of an exemplary embodiment of an apparatus for slicing a tissue section and transferring it to a slide in an automated manner. The apparatus includes a rotary microtome 302, which may be a previously existing design or a new design adapted for use with the apparatus and methods of the present disclosure. For example, the rotary microtome 302 may include a base 304 and a microtome housing 306 provided on the base 304. A knife holder 308 is located on the base 304. A sample holder 310 can be moved up and down by means of a handwheel 312 provided on microtome housing 306. The knife holder 308 and the sample holder 310 are arranged oppositely from one another. The knife holder 308 supports a front plate 316 (also called a knife pressure plate) which applies pressure to the knife 314. The knife holder 308 is supported by various clamps, supports and rails. The sample holder 310 can be adjusted to select the thickness sliced from a tissue sample. It also allows adjustment of the angle at which the knife 314 contacts the tissue sample.

The apparatus is operated as follows. A tissue sample is securely clamped or inserted into the sample holder 310, which is moved about the knife 314 and locked in place. The knife holder 308 is moved into the desired position, where it will slice a tissue section of desired thickness, and locked or clamped in place. The operator then turns the handwheel 312, lowering the sample holder 310 so the tissue sample engages the knife 314. In FIG. 3, a tissue section 341 has been sliced by the microtome and awaits collection from the front plate 316.

The apparatus includes a tissue collector 332 adapted for collecting a tissue section from the front plate 316 in an automated fashion. In FIG. 3, tissue section 330 has already been collected. The apparatus can comprise an automated tissue collector adapted for movement in relation to the knife, such that the tissue collector can contact the tissue section after slicing. For example, the tissue collector can be adapted for movement to (1) a position where a collecting end of the tissue collector is in contact with or in sufficient proximity to the tissue section such that the tissue section is collected by the tissue collector; and (2) a position where a tissue section on the collecting end is in contact with a slide held by the slide holder.

In some embodiments, the tissue collector does not employ an adhesive material but rather is configured for collecting the tissue section by suction, adhesive, friction, or other force. For example, the tissue collector 332 can include one or more apertures through which a reduced pressure (resulting in suction) is provided. Apertures are fluidly connected to a pneumatic source. The tissue collector 332 may include an extendible portion such as an arm 336 which contacts or comes close to the tissue section 330. When the tissue collector 332 or a portion thereof (such as an arm) makes contact with or is sufficiently close to the tissue section 330, the tissue section 330 is held to the tissue collector 332 by reduced pressure at the apertures. “Reduced pressure” refers to a pressure less than the surrounding environment or a sub-ambient pressure, whereas “positive pressure” refers to a pressure greater than the surrounding environment, such as greater than atmospheric pressure. The pressure gradient between positive pressure and the ambient pressure will propel a tissue section away from the positive pressure and toward the low pressure area. “Suction” refers to a flow of gas into a partial vacuum or region of reduced pressure. The pressure gradient between this region and the ambient pressure will cause the matter to move toward the reduced pressure area. In certain embodiments, a sub-atmospheric pressure is a reduced pressure.

In some embodiments, the tissue collector employs an adhesive material in place of or in addition to reduced pressure. The adhesive materials may be provided in any form, such as an adhesive strip. The term “strip” as used herein encompasses tape, bands, patches, and other relatively flat forms. Desirable adhesives for use in collecting a tissue section are those which provide sufficient strong adherence for movement, but do not adhere so strongly as to damage the tissue section when removed. Examples of such adhesives include low-tack pressure-sensitive adhesives, such as acrylonitrile copolymers ((e.g., butadiene-acrylonitrile polymers (BACN polymers), butadiene-acrylonitrile-isoprene polymers (BACNI polymers)); styrene copolymers (e.g., styrene/butadiene/styrene (SBS polymers), styrene/isoprene/styrene (SIS polymers), and styrene/ethylene/butylene/styrene (SEBS polymers)); and acrylate copolymers. Blends and mixtures of polymeric materials may be used if desired. The pressure sensitive adhesive may also contain sufficient antioxidants, UV stabilizers and crosslinking agents. Adhesive strips are available from various companies including 3M Company of Maplewood, Minnesota, Polymer Science, Inc. of Monticello, Indiana, and Adhesives Research, Inc. of Glen Rock, Pennsylvania.

An adhesive strip may be positioned on the tissue collector or an extendible portion thereof by reduced pressure at apertures, by an adhesive, by both, and/or by other means. For example, in FIG. 3, the tissue collector 332 has an adhesive strip 338 disposed on a collecting end. Tissue collector 332 comprises spools 337 on which adhesive strip 338 can be unwound and rewound after usage to collect the tissue section 330. More particularly, fresh adhesive strip is on first reel 337, and it is configured so as to extend across the collecting end of the tissue collector 332. After a portion of adhesive strip 338 has been used to collect a tissue section, the adhesive strip advances between reels, and used portions of adhesive strip are wound on a second reel (not visible in FIG. 3). The adhesive strip 338 contacts the tissue section 330 and adheres to it. In some embodiments, the adhesive material only contacts part of the tissue section, preferably a part that is only embedding medium and does not contain tissue. In other words, a first portion of the adhesive material attaches to the tissue section and a second portion of the adhesive material is on the tissue collector but does not attach to or contact the tissue section.

The tissue collector 332 is adapted for movement so that it can collect a tissue section from a microtome or other location and transfer it to a slide. For example, the apparatus can comprise an automated tissue collector attached to a rotating support whose rotation changes position of the automated tissue collector. In the embodiment shown in FIG. 3, the tissue collector 332 is adapted for rotational movement, as it is attached by a shaft 340 to a support 342. The support 342 can be operated manually or by automation, such as by a controller, and can rotate the shaft 340, which may contain wiring for the tissue collector 332. The support 342 can move the tissue collector 332 to first, second, and more positions where various operations are performed. As discussed above, the tissue collector 332 can be placed in a position to collect a tissue section 330 from a microtome. After that, the tissue collector can be rotated or otherwise moved so that it is in a position to transfer the tissue section to a slide 344.

After acquiring the tissue section, the arm 336 moves so that the tissue section is positioned near a slide 344. The arm may be adapted for rotational and/or linear motion. The arm or a portion thereof extends again so that the tissue section 330 and optionally an adhesive material makes contact with the slide, so that the tissue section can be attached to the slide.

In FIG. 3, the tissue collector 332 has been rotated, and an arm has been extended, so that the tissue section 330 and the adhesive material 338 are in motion toward contacting a slide 344 held by a slide holder 346. The tissue section 330 will contact the side of slide 344, and the adhesive strip 338 can also attach to the slide 344, particularly a portion of the adhesive strip which is not attached to the tissue section. Heat and/or physical force can be applied to the tissue section 330 or a portion thereof, such as the contact site of the tissue section and the slide, in an amount and for a time-sufficient to facilitate or increase attachment of the tissue section 330 to the slide 344. The arm 336 will be retracted, leaving the tissue section 330 on the slide 344. In some embodiments, the adhesive strip 338 can also be left on the slide 344, such as by cutting on or releasing the adhesive strip 338 on both sides, or simply halting a reduced pressure holding the adhesive material 338 to the tissue collector, thereby releasing the adhesive strip 338 from the tissue collector 332. In some embodiments, particularly when the adhesive strip 338 is provided on a reel, the adhesive material 338 is removed from the slide (manually or by automation when arm 336 retracts) so as to leave the tissue section 330 attached to slide 344 without adhesive.

After the tissue section has been transferred to the slide, the apparatus can be prepared for its next use. The tissue collector 332 can be rotated or otherwise moved to the microtome 302 to collect the next tissue section 341. A dispenser of adhesive materials can supply clean adhesive material to the collecting end. In embodiments where an adhesive material is provided as a continuous strip, the used adhesive strip is moved off the collecting end of the tissue collector, and clean adhesive strip is moved onto the collecting end. For example, when an adhesive strip is provided in a reel-to-reel arrangement, such as where the adhesive strip is provided or wound on a first reel, and the adhesive strip extends or unwinds from the first reel across the collecting end to a second reel. The adhesive strip can be advanced across the collecting end (unwinding a portion from the first reel and winding a portion on the second reel) after a first section of the adhesive strip is used to transfer a tissue section to a slide, whereby a second section of the adhesive strip is positioned on the collecting end. The tissue collector can be rotated or otherwise moved before, during or after the slicing of the next tissue section. The tissue collector, slide holder and slide may optionally be oriented in other axes than shown in FIG. 3 when the tissue section is mounted to the slide.

As mentioned, the tissue collector, or a portion thereof such as an arm, may be adapted to move so that it is in position to contact and/or collect the tissue section. The exterior surface of the tissue collector or the arm can be flat, cylindrical, octagonal, or another shape and can be adapted for additional movement. For example, an arm of the tissue collector may be adapted to extend and retract along a track in the main body of the tissue collector 332, so that an arm 336 can be extended to the tissue section or the slide, make contact with the tissue section or the slide, and be retracted, thereby allowing a collecting end of the tissue collector to be in contact with or in sufficient proximity to the tissue section such that the tissue is collected by the tissue collector. In some embodiments, the arm is capable of rotational motion, so that the end can be rotated between positions where it contacts and/or collects the tissue section and where it deposits the tissue section on to a slide. Optionally, the arm or tissue collector is adapted for rotation to other positions where other functions or steps are performed.

In some embodiments of the present apparatus, the slide is held by a slide holder 346, which may also be automated. The slide holder 346 can be rotated or otherwise moved along, or it can be attached to a slide holder base 350 that provides such movement. For example, slide holder base 350 can move along track 352 into proximity with bath 360. The slide holder 346 or the slide holder base 350 may be adapted to move so that it is in position to contact the bath 360. In some embodiments, the slide holder 346 or the slide holder base 350 is capable of rotational motion, so that the angle of the slide 344 can be changed. Optionally, the slide holder 346 or the slide holder base 350 is adapted for rotation to other positions where other functions or steps are performed. The apparatus of FIG. 3 further comprises a controller 370 in signal communication to the slide holder base 350 and the tissue collector 332.

The slide holder can transport the slide 344 to a slide bath 360, which may comprise warm water or may be sequentially filled with cool or room temperature water (or other liquid), following by warm water (or other liquid). In some embodiments, the apparatus comprises more than one slide bath which may be at the same or different temperatures or contain the same or different liquids. For instance, two separate water baths may be provided, one at room temperature and one at an elevated temperature. Other slide bath configurations can be used as well. The slide holder 346 can be located near one of the positions of the tissue collector and capable of motion to submerge a held slide into the slide bath. Contacting the tissue section on the slide with the warm flattens the tissue section on the slide. The sequence of contacting the tissue section on the slide with cool water followed by warm water promotes the flattening of the tissue section on the slide, without bunching or bubbles. The adhesive strip can be removed (if it has not been removed already), or a portion of adhesive material can remain on the slide, so long as it does not interfere with analysis of the tissue. The tissue section flattened on the slide is generally ready for other processing (deparaffination, stringency washing, cover slipping, staining, enzymatic treatment, etc.).

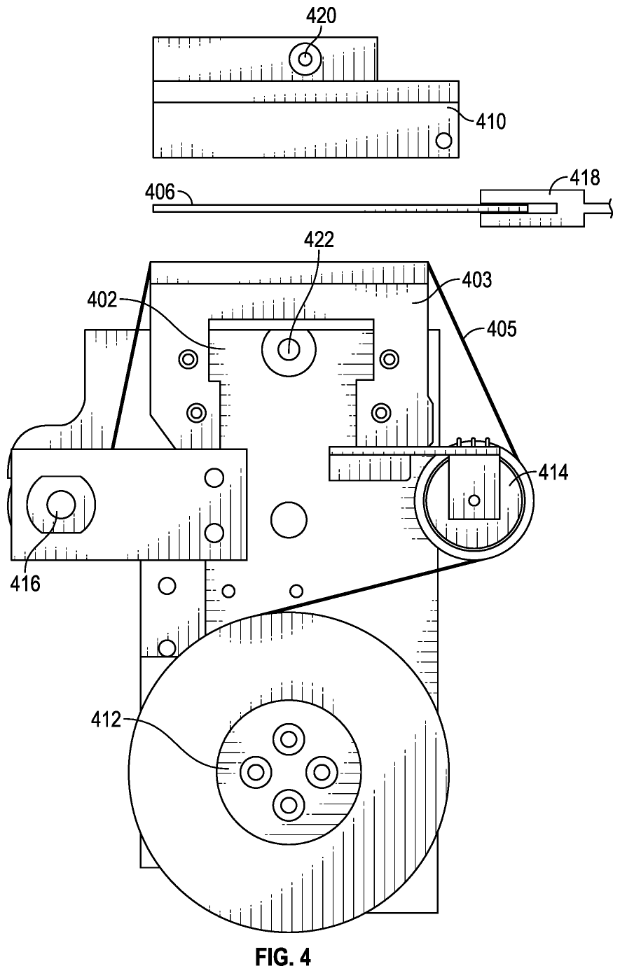

FIG. 4 illustrates an exemplary embodiment of a tissue collector configured to provide an adhesive strip at its collecting end. Tissue collector 402 is capable of rotational movement and linear movement. A collecting end 403 of the tissue collector 402 can be any size or shape desired, for example, substantially flat, optionally with rounded edges. The apparatus also comprises an adhesive material dispenser proximate to a collecting end 403 of the tissue collector 402, so that collecting end 403 of tissue collector has an adhesive strip 405 on it. More particularly, adhesive strip 405 extends across collecting end 403 from a first reel 412 and over wheel 414 to second reel 416. Wheel 414 can be moved to make adhesive strip 405 tight or loose between the reels and on the collecting end. In some embodiments, wheel 414 is a tachometer which provides a measurement of how much of the adhesive strip has been advanced. First reel 412 has clean, unused adhesive strip 405 wound around it, and second reel 416 has used adhesive strip wound around it. After the portion of adhesive strip covering the collecting end is used to collect tissue or debris, the adhesive strip can be advanced by the reels, so that used adhesive strip is wound on second reel 416. A variety of additional or different elements than those illustrated in FIG. 4 can be employed to apply tension to the adhesive strip. In some embodiments, the apparatus includes an actuator that clamps the unused adhesive strip to a surface of the collecting end 403 (such as a top surface facing the slide or a side surface) when the wheel 414 is not spooling more adhesive strip over the collecting end 403.

Tissue collector 402 is capable of linear movement toward slide 406, so that when a tissue section has been collected at collecting end 403, tissue collector can bring it into contact with slide 406, which is held by slide holder 418. On an opposite side of slide 406, heating element 410 is present and is capable of linear motion toward slide 406. Heating element 410 can be maintained at a desired temperature or can be configured to rapidly heat up when desired for use. Heating element 410 contacts a side of slide 406 opposite to the side in contact with a tissue section. Heating element 410 may be configured such that it only contacts a portion of the slide. Applying heat from the opposite side reduces risk of damage to the tissue section.

It is also contemplated that heating element 410 remains stationary while slide holder 406 and tissue collector 402 move so as to bring them all into contact. It is also contemplated that heating element 410 can be omitted, and/or that collecting end 403 comprises a heating element, so that heat can be applied to the tissue section from the collecting end 403. Surfaces on tissue collector 402 and heating element 410 which will face the tissue section can be configured for rotation, such has by including pivot 422 in tissue collector 402 and pivot 420 in heating element 410.

Through the use of the apparatus and method described herein, a tissue section may be transferred from a microtome to a slide without manual action on the tissue section, in an automated manner. A tissue section may be transferred without manual contact with the tissue section, such as the manual contact of a user grasping the tissue section by hand or with a handheld instrument. More particularly, a freshly-sliced tissue section may be removed from a microtome without manual contact, and/or a tissue section may be placed on a slide without manual contact. The apparatus and methods also enable slicing and transferring of tissue sections having good two-dimensional stability, with bunching or curling, and avoid waste of tissue sections.

### Exemplary Embodiments

Exemplary embodiments provided in accordance with the presently disclosed subject matter include, but are not limited to, the following:

Embodiment 1. A method for transferring a tissue section onto a slide, comprising: collecting a tissue section with a tissue collector and/or an adhesive strip; moving the tissue collector and/or the adhesive strip to bring at least a portion of the tissue section in contact with a slide; applying physical force, heat or both to the tissue section at a contact site of the tissue section with the slide.

Embodiment 2. The method of embodiment 1, comprising heating the tissue section at the contact site to a temperature between about 40° C. and about 90° C.

Embodiment 3. The method of embodiment 1 or embodiment 2, wherein the tissue section comprises an embedding medium, and the heat is sufficient to at least partially melt the embedding medium.

Embodiment 4. The method of any of the foregoing embodiments, comprising applying physical force of about 275 kPA or less to the tissue section at the contact site.

Embodiment 5. The method of any of the foregoing embodiments, wherein the contact site is 25% or less of the tissue section.

Embodiment 6. The method of any of the foregoing embodiments, further comprising positioning the adhesive strip on a collecting end of the tissue collector.

Embodiment 7. The method of embodiment 6, comprising collecting the tissue section by adhering to the adhesive strip.

Embodiment 8. The method of embodiment 6, wherein the adhesive strip is provided on a first reel, and the adhesive strip extends from the first reel across the collecting end to a second reel.

Embodiment 9. The method of embodiment 8, advancing the adhesive strip across the collecting end (unwinding a portion from the first reel and winding a portion on the second reel) after a first section of the adhesive strip is used to transfer a tissue section to a slide, whereby a second section of the adhesive strip is positioned on the collecting end.

Embodiment 10. The method of any of the foregoing embodiments, wherein the adhesive strip comprises low-tack pressure-sensitive adhesives.

Embodiment 11. An apparatus for transferring a tissue section to a slide, comprising: a tissue collector adapted for collecting the tissue section; a slide holder adapted for holding a slide; wherein the tissue collector and/or the slide holder is configured for movement such that a tissue section collected by the tissue collector and a slide held by the slide holder contact each other at a contact site; a heating element positioned at, or configured for movement to, the contact site.

Embodiment 12. The apparatus of embodiment 11, wherein the heating element is contained within the tissue collector.

Embodiment 13. The apparatus of embodiment 11, wherein the heating element is contained within the slide holder.

Embodiment 14. The apparatus of any of embodiments 11 to 13, wherein the heating element is outside the tissue section and the slide holder, and the heating element is positioned, or capable of movement to a position, on a first side of a slide held by the slide holder, wherein the contact site is a second, opposite side of the slide.

Embodiment 15. The apparatus of any of embodiments 11 to 14, further comprising a dispenser for an adhesive material.

Embodiment 16. An apparatus for transferring a tissue section to a slide, comprising: a tissue collector adapted for collecting the tissue section; a slide holder adapted for holding a slide; wherein the tissue collector and/or the slide holder is configured for movement such that a tissue section collected by the tissue collector and a slide held by the slide holder contact each other at a contact site; and an adhesive strip dispenser capable of dispensing an adhesive strip at the collecting end of the tissue collector.

Embodiment 17. The apparatus of embodiment 16, wherein the adhesive strip dispenser comprises at least two reels on opposite sides of the collecting end, whereby an adhesive strip extends from a first reel across the collecting end to a second reel, and the first reel is capable of unwinding fresh adhesive strip, and the second reel is capable of winding used adhesive strip.

Embodiment 18. The apparatus of embodiment 17, wherein the collecting end of the tissue collector is extendible.

Embodiment 19. The apparatus of embodiment 17 or embodiment 18, wherein the tissue collector is configured to transfer the tissue section by application of physical force and/or heat at or near the slide holder.

Embodiment 20. The apparatus of any of embodiments 16 to 19, wherein the tissue collector or the slide holder comprises a heating element.

The foregoing description of exemplary or preferred embodiments should be taken as illustrating, rather than as limiting the present invention as defined by the embodiments. As will be readily appreciated, numerous variations and combinations of the features set forth above can be utilized without departing from the present invention as set forth in the embodiments. Such variations are not regarded as a departure from the scope of the invention, and all such variations are intended to be included within the scope of the following embodiments. All references cited herein are incorporated by reference in their entireties.

We claim:

1. A method for transferring a tissue section onto a slide, comprising:
collecting a tissue section with a tissue collector and/or an adhesive strip;
moving the tissue collector and/or the adhesive strip to bring at least a portion of the tissue section in contact with a slide;
applying physical force, heat or both to the tissue section at a contact site of the tissue section with the slide.

2. The method of claim 1, comprising heating the tissue section at the contact site to a temperature between about 40° C. and about 90° C.

3. The method of claim 1, wherein the tissue section comprises an embedding medium, and the heat is sufficient to at least partially melt the embedding medium.

4. The method of claim 1, comprising applying physical force of about 275 kPA or less to the tissue section at the contact site.

5. The method of claim 1, wherein the contact site is 25% or less of the tissue section.

6. The method of claim 1, further comprising positioning the adhesive strip on a collecting end of the tissue collector.

7. The method of claim 6, comprising collecting the tissue section by adhering to the adhesive strip.

8. The method of claim 6, wherein the adhesive strip is provided on a first reel, and the adhesive strip extends from the first reel across the collecting end to a second reel.

9. The method of claim 8, advancing the adhesive strip across the collecting end after a first section of the adhesive strip is used to transfer a tissue section to a slide, whereby a second section of the adhesive strip is positioned on the collecting end.

10. The method of claim 1, wherein the adhesive strip comprises low-tack pressure-sensitive adhesives.

11. An apparatus for transferring a tissue section to a slide, comprising:
a tissue collector adapted for collecting the tissue section;
a slide holder adapted for holding a slide;
wherein the tissue collector and/or the slide holder is configured for movement such that a tissue section collected by the tissue collector and a slide held by the slide holder contact each other at a contact site;
a heating element positioned at, or configured for movement to, the contact site.

12. The apparatus of claim 11, wherein the heating element is contained within the tissue collector.

13. The apparatus of claim 11, wherein the heating element is contained within the slide holder.

14. The apparatus of claim 11, wherein the heating element is outside the tissue section and the slide holder, and the heating element is positioned, or capable of movement to a position, on a first side of a slide held by the slide holder, wherein the contact site is a second, opposite side of the slide.

15. The apparatus of claim 11, further comprising a dispenser for an adhesive material.

16. An apparatus for transferring a tissue section to a slide, comprising:
a tissue collector adapted for collecting the tissue section;
a slide holder adapted for holding a slide;
wherein the tissue collector and/or the slide holder is configured for movement such that a tissue section collected by the tissue collector and a slide held by the slide holder contact each other at a contact site; and
an adhesive strip dispenser capable of dispensing an adhesive strip at the collecting end of the tissue collector.

17. The apparatus of claim 16, wherein the adhesive strip dispenser comprises at least two reels on opposite sides of the collecting end, whereby an adhesive strip extends from a first reel across the collecting end to a second reel, and the first reel is capable of unwinding fresh adhesive strip, and the second reel is capable of winding used adhesive strip.

18. The apparatus of claim 17, wherein the collecting end of the tissue collector is extendible.

19. The apparatus of claim 17, wherein the tissue collector is configured to transfer the tissue section by application of physical force and/or heat at or near the slide holder.

20. The apparatus of claim 16, wherein the tissue collector or the slide holder comprises a heating element.
